(19) United States
(12) Patent Application Publication
(10) Pub. No.: US 2010/0306144 A1
(43) Pub. Date: Dec. 2, 2010

(54) SYSTEM AND METHOD FOR CLASSIFYING INFORMATION

(76) Inventors: Martin B. Scholz, San Francisco, CA (US); Somnath Banerjee, Bangalore (IN)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/476,821

(22) Filed: Jun. 2, 2009

(51) Int. Cl. G06F 15/18

(52) U.S. Cl. 706/20; 707/E17.014

(57) ABSTRACT

An exemplary embodiment of the present invention provides a computer implemented method for classifying information. The method may include accessing a plurality of information sources to identify example information items for each of a plurality of classification categories. Each of the example information items may be analyzed to generate a training corpus for each information source for each of the classification categories. The training corpus for each of the information sources may be combined to generate a training set for each of the classification categories, wherein the training set may be configured to allow the generation of a classification function.

### BACKGROUND

The World-Wide Web (or Web) provides numerous search engines for locating Web-based content. Search engines allow users to enter keywords, which can then be used to identify a list of documents such as Web pages. The Web pages are returned by the keyword search as a list of links that are generally sorted by the degree of match to the keywords. The list can also have paid links that are not as closely matched to the keywords, but are given a higher priority based on fees paid to the search engine company.

Further, as the World-Wide Web (or Web) has progressed in content and complexity, a new paradigm for the generation of Web content has emerged. This paradigm can be loosely termed Web 2.0 and relates to the generation of Web content by a large number of collaborative users, such as on-line encyclopedias (for example, WIKIPEDIA™), social indexing sites (for example, DMOZ™, DELICIOUS™), social networking sites (for example, FACEBOOK™, MYSPACE™), social commentary sites (for example, TWITTER™), and news sites (for example, REUTERS™ or MSNBC™).

### BRIEF DESCRIPTION OF THE DRAWINGS

Certain exemplary embodiments are described in the following detailed description and in reference to the drawings, in which:

FIG. 1 is block diagram of a network domain that can be used to generate a training set for the classification of content objects or to classify content objects, in accordance with an exemplary embodiment of the present invention;

FIG. 2 is a block diagram of a method for generating a training set for classifying objects, in accordance with exemplary embodiments of the present invention;

FIG. 3 is a block diagram of a method for classifying objects, in accordance with exemplary embodiments of the present invention;

FIG. 4 is functional block diagram of a computing device for classifying content, in accordance with an exemplary embodiment of the present invention;

FIG. 5 is a map of code blocks on a tangible, computer-readable medium, according to an exemplary embodiment of the present invention; and

FIG. 6 is a bar chart comparing classification results for training sets taken from each of the target Web sites used, in accordance with exemplary embodiments of the present invention.

### DETAILED DESCRIPTION OF SPECIFIC EMBODIMENTS

The classification of textual documents is a machine learning task that can have a wide variety of applications. For example, a classifier can be applied to Web content for the categorization of news and blog content, spam filtering, and the filtering of Web content objects (such as pages, text messages, and the like) with respect to user-specific interests. As used herein, the term “exemplary” merely denotes an example that may be useful for clarification of the present invention. The examples are not intended to limit the scope, as other techniques may be used while remaining within the scope of the present claims. A classifier according to an exemplary embodiment of the present invention is constructed of hardware elements, software elements or some combination of the two. Classification tools can also allow automatic sorting of particular topics from continuous feeds in real time, providing a number of useful functions. For example, content objects classified as relevant to a particular topic can be forwarded to an appropriate consumer, such as a user system.

The large volume of content available on the Web makes classifying specific content challenging. Although certain sites can have users classify the content they provide, many sites provide no classification data. Further, search engines allow keywords to be located, but they do not classify the results. Classification engines can be generated, for example, by using personnel to classify particular Web pages in order to generate training sets, but this is generally too expensive for practical use.

In an exemplary embodiment of the present invention, a classifier (using a classification function) is constructed for classifying information. The information may include text messages, articles, and other content objects. The content objects may then be forwarded or sorted based on the classification. Using this system, for example, a news writer could be automatically forwarded any content objects that deal with a particular subject, such as politics. Further, content generators could use an automated content classifier to sort and forward content to subscribers.

Generally, the classification of text has been based on manually generated sample sets to identify single labels, or classification categories, in which an independent, identically distributed (IID) assumption applied. The text, labels, and categories generally include words, e.g., alpha-numeric character sequences that are divided from each other by spaces or other punctuation characters. Each label or category may represent a concept. In textual classification, the IID assumption assumes that a training set and a test set are sampled from the same underlying distribution. This assumption can simplify the classification process, for example, by assuming that cross-validation results are reliable indicators for how well the target concept has been learned.

However, Web 2.0 content may not fit the IID assumption as different pages can be prepared by different persons. Thus, usages can be incorrect on pages (termed “noise”), definitions can vary between sites (termed “contextual variation”), and target concepts can change meaning over time (termed “context drift”). A classification function that performs well on a broad variety of pages, ranging from clean dictionary entries to noisy content feeds, would be useful. Accordingly, the automatic gathering of test data from the Web would facilitate the generation of such classification functions.

An exemplary embodiment of the present invention includes a general framework that gathers training examples and labels automatically using various sources on the Web. Further, as different Web sources can have different underlying distributions, exemplary embodiments of the present invention provide strategies for combining sources having different distributions to obtain broadly applicable classifiers.

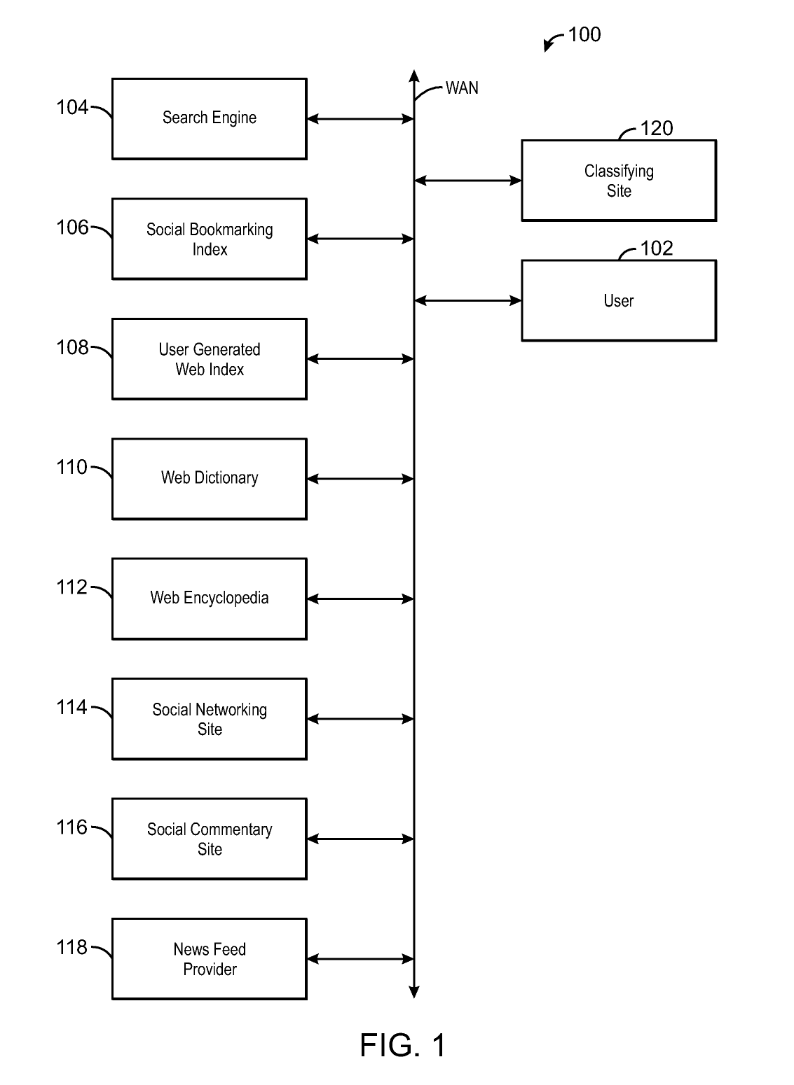

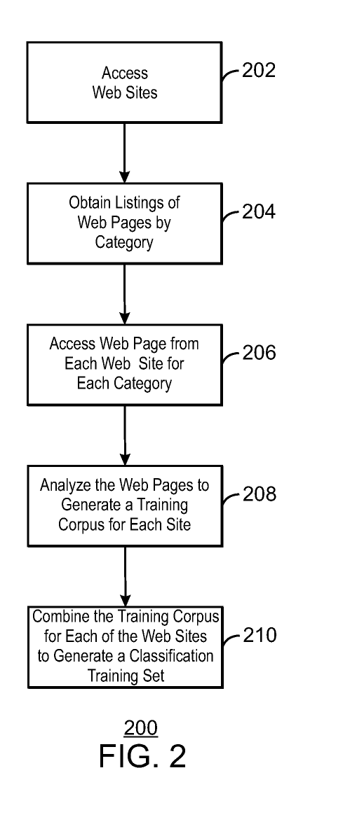

FIG. 1 is block diagram of a network domain 100 that can be used to generate a training set for the classification of content objects or to classify content objects, in accordance with an exemplary embodiment of the present invention. The network domain 100 may include a wide area network (WAN), a local area network (LAN), the Internet, or any other suitable network domain and associated topology. Moreover, FIG. 1 shows a plurality of information sources that may provide information items that can be categorized by a method according to an exemplary embodiment of the present invention. A method according to an exemplary embodiment of the present invention is described below with reference to FIG. 2.

The network domain 100 can couple numerous systems together. For example, a user system 102 can access information items (such as Web pages, text messages, articles, and the like) on various systems, for example, a search engine 104 (such as GOOGLE™ or ALTAVISTA™), a social bookmarking index site 106 (such as DELICIOUS™), a user-generated Web index site 108 (such as DMOZ™), a Web-based dictionary 110 (such as MERRIAM-WEBSTER™), a Web encyclopedia 112 (such as WIKIPEDIA™), a social networking site 114 (such as FACEBOOK™), a social commentary site 116 (such as TWITTER™), a news provider 118 (such as REUTERS™), among many others. Each of the content sites can generally include numerous servers, for example, in an internal network or cluster configuration.

In an exemplary embodiment of the present invention, the content objects from the various sources shown in FIG. 1 is classified and presented on a browser screen on the user system 102 along with the classification. In addition, the classification scheme developed according to an exemplary embodiment of the present invention can be used to sort or filter the content objects.

In another exemplary embodiment of the present invention, the classification of content objects is performed at a classifying site 120, which is separate from the user's system 102. In this exemplary embodiment of the present invention, the classifying site 120 can be used as part of a subscription service to provide content to users. The classifying site 120 can be implemented on one or more web servers and/or application servers.

Each of the different content sites shown in FIG. 1 can provide different types of content and can use terms in slightly different contexts. For example, various types of Web sites that provide useful content for generating training sets for content classification may include a search engine 104, a social bookmarking index site 106, a user generated Web index site 108, a Web dictionary 110, a Web encyclopedia 112, a social networking site 114, a social commentary site 116, or a news provider 118, among others.

The search engine 104 provides a simple interface to obtain Web pages for any given concept. However, while Web pages found by the search engine 104 can be relevant to the search term, it does not necessarily define the term or provide any kind of descriptive content. Thus, many of the Web pages identified by the search engine 104 can have a low relevance to the content. For example, the start pages of portals linking to topic-specific sub-pages can often result from Web searches, but they can contain a substantial amount of advertising material in addition to any descriptive text. In exemplary embodiments of the present invention, content from the search engine 104 is combined with content from other types of sites to increase the strength of training sets that are useful for machine learning.

The social bookmarking index site 106 allows users to save and tag universal resource locators (URLs) for access by other users. These types of sites, for example, DELICIOUS™, are often organized by a concept mentioned in a Web page referenced by the URL and, thus, can provide tags that are representative of the concept. Accordingly, pages tagged with a concept name can be thought of as the positive examples for that concept. The social bookmarking index site 106 can capture semantics in a way that resembles human perception at an appropriate level of abstraction. Further, the social bookmarking index site 106 may avoid unnatural assumptions, such as the assumption that categories are mutually exclusive. DELICOUS™ provides an application programming interface (API) to obtain Web pages with any specified tag. In an exemplary embodiment of the present invention, as discussed in further detail below, the DELICIOUS™ API is used to obtain pages tagged with the term “photography.”

The user generated Web index site 108 can also provide a useful source of information for building training sets for content classification. For example, DMOZ™ is a human edited Web directory that contains almost 5 million Web pages, categorized under nearly 600,000 categories. Each category in DMOZ™ represents a concept and the categories are organized hierarchically, for example, by listing “underwater photography” as a sub-category of “photography.” Generally, DMOZ™ is organized by natural concepts that can be interpreted by a user and every page is interpreted and classified by a human annotator.

The user-edited Web encyclopedia 112 can also be used to obtain training sets for classifiers. For example, WIKIPEDIA™ is a community-edited Web encyclopedia containing Web pages in many different languages. WIKIPEDIA™, and other exemplary encyclopedias such as the user-edited Web encyclopedia 112, can have a number of properties that are useful for generating training sets. For example, WIKIPEDIA™ is semi-structured in nature, with no a-priori labels identifying the content. Therefore, the concepts can be more thoroughly explored than other considered sources. Further, WIKIPEDIA™ has very clean pages (in other words, a high information content with no advertising), which provide definitions and refer to related concepts.

FIG. 2 is a block diagram of a method 200 for generating a training set for classifying objects, in accordance with exemplary embodiments of the present invention. The method 200 may be performed on either a user system 102 or a separate classifying site 120, as discussed with respect to FIG. 1. Further, each of the blocks in the method 200 may represent software modules, hardware modules, or a combination thereof. The method 200 begins at block 202 with the accessing of a number of different Web sites (information sources) that have topics categorized by subject, such as DMOZ™, DELICIOUS™, WIKIPEDIA™, GOOGLE™, among others. Examples of such Web sites are set forth above with respect to FIG. 1. From each of these Web sites (information sources), sub-pages (information items) can be retrieved for a number of categories. In other exemplary embodiments of the present invention, content can be retrieved for the target Web sites and analyzed off-line. At block 204, listings of Web pages organized by categories are obtained from each of the Web pages. At block 206, each of the Web pages in each category for each of the target Web sites are accessed.

At block 208, the Web pages are analyzed to generate an individual training set, or training corpus, for each Web site. A number of Web pages can be withheld from the generation of the training corpus for testing purposes. For example, if 1,000 Web sites are accessed, 900 can be used to generate the training corpus, while the remaining 100 can be used to test the ability of the corpus to categorize sites.

In an exemplary embodiment of the present invention, the analysis of the Web sites to generate the training corpus is performed by processing each of the Web pages to remove non-textual content. The remaining content can be processed by applying weighting or frequency functions to weight the importance of the words in the Web page. After the weighting function, examples of Web pages that contain or belong to a target concept are identified as positive examples, while Web pages that are not identified with a concept are defined as negative examples. The training set may be used by any number of machine-learning techniques to determine classification functions for placing content objects, such as articles, pages, text messages, and the like, into particular classification categories. The classification categories generally include concepts, topics, sub-topics, words from headings, words from titles, subjects, activities, and the like. For example, a support vector machine (SVM) can then be used to develop a binary classifier for each category as discussed further below. As used herein, the classification function (or classifier) may include the SVM, the binary classifier, a classifier that uses the SVM to generate a classification factor that indicates whether a content object is within a particular category, or any combinations thereof. Further, the classification function may be used to generate a probability function that generates a probability indicating whether a page belongs to a particular classification.

Generally, an SVM is a supervised learning method used for classification. If training data is classified as two sets of vectors in an n-dimensional space (for example, as Web content that represents positive and negative examples of a target concept), an SVM will construct a hyperplane that separates the two sets of vectors in that space. The construction is performed so as to maximize the distance between the hyperplane and the closest point in each of the two data sets. A larger separation can lower the error of the classifier.

Web content that is on the same side of the hyperplane as the positive examples can be classified as belonging to the target concept. Similarly, Web content that is on the same side of the hyperplane as the negative examples can be classified as not belonging to the target concept.

At block 210, the training corpus for each of the target Web sites can be combined to develop a single, more general classifier. For example, a separate classifier could be developed for each training set. In an exemplary embodiment of the present invention, the individual classifiers can then be used to classify a Web content object, wherein a final classification of the content object is made according to a majority vote of the classifiers (for example, classification functions) for each training set. In another exemplary embodiment, the results from a portion of the Web site classifiers are used to weight the results from another portion of the Web site classifiers. The weighting can be used to eliminate terms that are not correctly defined or used, increasing the strength of the classification.

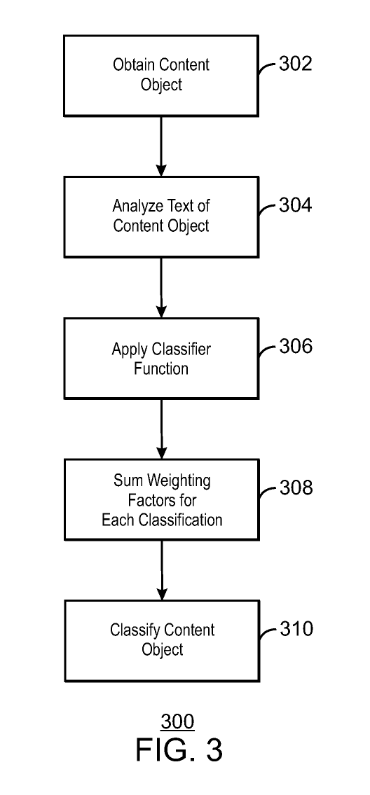

FIG. 3 is a block diagram of a method 300 for classifying content objects, in accordance with exemplary embodiments of the present invention. The classification may be performed by the user system 102 or by a separate classifying site 120, as discussed with respect to FIG. 1. Further, each of the blocks in the method 300 may represent software modules, hardware modules, or a combination thereof. At block 302 the classifier identifies, obtains, or is provided with a content object. The content object can be, for example, an article, a message, a Web page, a text block, an e-mail message, or any combinations thereof. At block 304, the text of the content object is analyzed to determine word identities and occurrence frequencies. A classifier function is applied to the word data obtained from the analysis of the content object, as indicated at block 306. In one exemplary embodiment, an SVM is used to generate the classifier function. In other embodiments, other machine-learning techniques could be used, such as pattern matching, stochastical analysis, and statistical analysis, among others.

In exemplary embodiments of the present invention, the classifier function can be generated by the techniques discussed herein. The classifier function generates a weight for each term in the content object, either negative or positive, that indicates that the object is within a particular classification. At block 308, the classifiers for each of the words for each of the concepts can be summed, generating a positive or negative value for each concept. At block 310, the content object is classified by determining whether the value of the summed classifier is positive or negative. If the classifier is positive, the content object is classified as belonging to that concept.

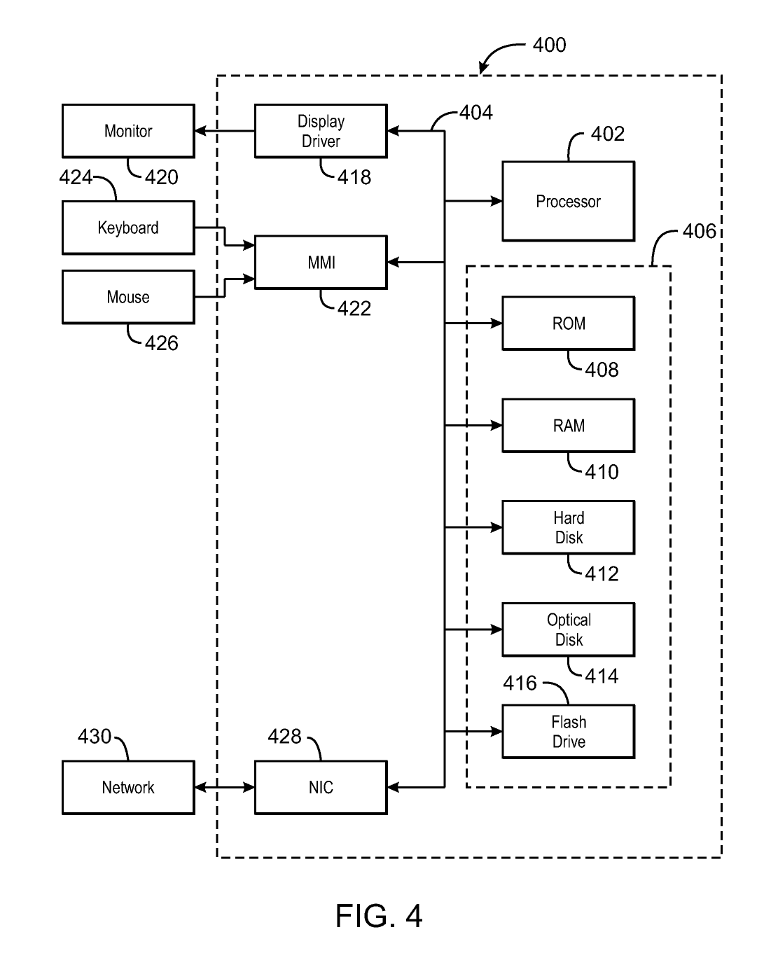

FIG. 4 is a block diagram of a computing device 400, in accordance with exemplary embodiments of the present invention. The computing device 400 can have a processor 402 for booting the computing device 400 and running other programs. The processor 402 can use one or more buses 404 to communicate with other functional units. The buses 404 can include both serial and parallel buses, which can be located fully within the computing device 400 or can extend outside of the computing device 400.

The computing device 400 will generally have tangible, computer readable media 406 for the processor 402 to store programs and data. The tangible, computer readable media 406 can include read only memory (ROM) 408, which can store programs for booting the computing device 400. The ROM 408 can include, for example, programmable ROM (PROM) and electrically programmable ROM (EPROM), among others. The computer readable media 406 can also include random access memory (RAM) 410 for storing programs and data during operation of the computing device 400. Further, the computer readable media 406 can include units for longer term storage of programs and data, such as a hard drive 412 or an optical disk drive 414. One of ordinary skill in the art will recognize that the hard drive 412 does not have to be a single unit, but can include multiple hard drives or a drive array. Similarly, the computing device 400 can include multiple optical drives 414, for example, compact disk (CD)-ROM drives, digitally versatile disk (DVD)-ROM drives, CD/RW drives, DVD/RW drives, Blu-Ray drives, and the like. The computer readable media 406 can also include flash drives 416, which can be, for example, coupled to the computing device 400 through an external universal serial bus (USB).

The computing device 400 can be adapted to operate as a classifier according to an exemplary embodiment of the present invention. Moreover, the tangible, machine-readable medium 406 can store machine-readable instructions such as computer code that, when executed by the processor 402, cause the computing device 400 to perform a method according to an exemplary embodiment of the present invention.

The computing device 400 can have any number of other units attached to the buses 404 to provide functionality. For example, the computing device 400 can have a display driver 418, such as a video card installed on a PCI or AGP bus or an integral video system on the motherboard. The display driver 418 can be coupled to one or more monitors 420 to display information from the computing device 400. For example, the computing device 400 can be adapted to transform data classified according to an exemplary embodiment of the present invention into a visual representation of a physical system that is displayed on the monitor 420. In this case, the physical system is classified data that is presented to the user, such as classified Web pages, Web sites, text messages, news articles, and the like.

The computing device 400 can have a man-machine interface (MMI) 422 to obtain input from various user input devices, for example, a keyboard 424 or a mouse 426. The MMI 422 can also include software drivers to operate an input device connected to an external bus (for example, a mouse connected to a USB) or can include both hardware and software drivers to operate an input device connected to a dedicated port (for example, a keyboard connected to a PS2 keyboard port).

Other units can be coupled to the buses 404 to allow the computing device 400 to communicate with external networks or computers. For example, a network interface controller (NIC) 428 can facilitate communications over an Ethernet connection between the computing device 400 and an external network 430, such as a local area network (LAN) or the Internet.

The computing device 400 can be a server, a laptop computer, a desktop computer, a netbook computer, or any number of other computing devices 400. Different types of computing devices 400 can have different configurations of the devices listed above. For example, a server may not have a dedicated monitor 420, keyboard 424 or mouse 426, instead using a network interface to connect to a managing computer system.

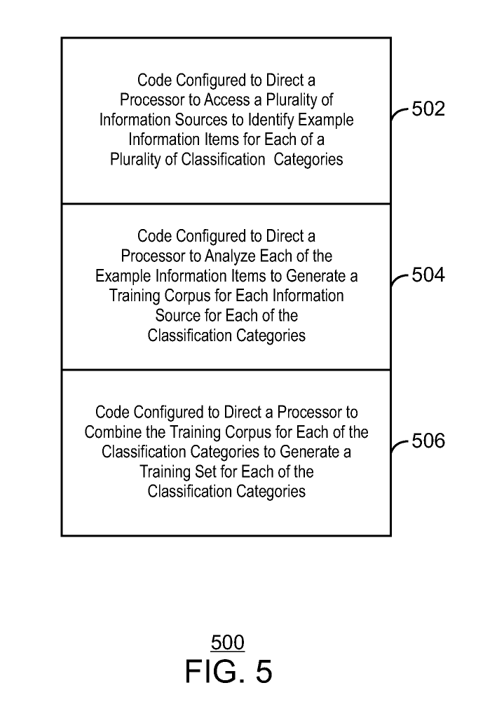

FIG. 5 is a map of code blocks on a tangible, computer-readable medium, according to an exemplary embodiment of the present invention. The tangible, computer-readable medium shown in FIG. 5 may be any of the units shown as block 406 in FIG. 4, among others. For example, the tangible, computer-readable medium may contain a code block configured to direct a processor to access a plurality of information sources to identify example information items for each of a plurality of classification categories, as shown in block 502. Further, as shown in block 504, the tangible, computer-readable medium may contain a code block configured to direct a processor to analyze each of the example information items to generate a training corpus for each information source for each of the classification categories. The tangible, computer-readable medium may also contain a code block (506) configured to direct a processor to combine the training corpus for each of the classification categories to generate a training set for each of the classification categories, wherein the training set is configured to allow the generation of a classification function. The code blocks are not limited to that shown in FIG. 5. In other exemplary embodiments, the code blocks may include code for classification of content objects. Further, the code blocks may be arranged or combined in different configurations from that shown.

Exemplary embodiments of the present invention discussed above are elucidated by examining the results of experiments that empirically evaluated various actual data. For the experiments, a set of ten diverse concepts were selected for the classification categories. These concepts were health, shopping, science, programming, photography, linux, recipes, Web design, humor and music. In order to simplify the experiments, the test concepts were each chosen to match a category name in DMOZ™ and a tag in DELICIOUS™. However, the concepts chosen were not required to match, since any number of very similar classification categories could be substituted if there were no exact match to a selected concept between different Web sites. The selected concepts span across three different levels of the DMOZ™ hierarchy and therefore vary considerably in terms of specificity. As discussed with respect to block 202 of FIG. 2, each of the Web sites used as information sources were accessed to obtain information items for building the training corpora.

For each of the ten concepts, a separate training corpus was constructed from each of the four different sources. Each corpus contained 1,000 positive examples (i.e., Web pages that were believed to represent the concept) and an equal number of negative examples (i.e., Web pages that were believed to not represent the concept). As discussed with respect to block 204 of FIG. 2, lists of Web pages (information items) were obtained from each of the Web sites (information sources). The raw Web pages (information items) were retrieved, as discussed with respect to block 206 of FIG. 2. Specific examples of the approach used to obtain Web pages from each of the Web sites (information sources) to generate training corpora are discussed below.

To generate a set of examples useful for the generation of training corpora for DMOZ™, a data dump of DMOZ™ from a specific date was analyzed. All Web pages (information items) referenced for each of the individual concepts in that dump were retrieved. Web pages in the sub-tree for any specific category were used as the positive examples of the corresponding class and the remaining Web pages as negative examples of the corresponding class. For each concept, 1,000 positive examples of Web pages that represent a concept were identified by a breadth first search (BFS) in the corresponding sub-trees of relevant categories. An equal amount of negative examples, or Web pages that do not represent a concept, were chosen at random from Web pages outside those trees. As used herein, a BFS is a graph search algorithm that sequentially analyzes all of the nodes in a data structure, starting from the root node and proceeding through each hierarchical level of the data structure.

To generate a set of examples useful for the generation of training corpora for GOOGLE™, the target concept name (for example, photography) was entered as a search query. The first 1,000 listed results Web pages were used as positive examples. A corresponding group of 1,000 negative examples was selected from DMOZ™ in the same way as described above.

To generate a set of examples useful for the generation of training corpora for DELICIOUS™, the category name was entered as a tag into the API to obtain Web pages tagged with the category name. The first 1,000 available Web pages were used as positive examples. An equal number of negative examples from DMOZ™ were chosen as outlined above.

To generate a set of examples useful for the generation of training corpora for WIKIPEDIA™, a WIKIPEDIA™ dump was obtained. An index of the dump was then generated. The target concept was used as the search query to the index, in the same way as described for the GOOGLE™ corpus. The first 1,000 Web pages identified by the search were used as positive examples. For selecting negative examples for a concept, the first 2,000 Web pages returned by the index search for each concept were excluded and 1,000 negative examples were sampled from the remaining Web pages.

Each of the raw Web pages (information items) was analyzed to generate the training corpus for each site, as generally discussed with respect to block 208 of FIG. 2. During the analysis, each Web page was processed to remove any non-textual content, such as HTML tags and scripts. The remaining words, for example, blocks of contiguous alpha-numeric content separated by spaces or punctuation characters, were tokenized to form a list, e.g., a collection of words, which was the data structure used in these experiments. Other suitable data structures, such as heaps, trees, and so forth, could have been used in place of lists, depending on the structural requirements for the particular machine-learning algorithm used.

Non-substantive words, such as “the,” “and,” and the like, were removed. A Porter stemming algorithm was applied to the remaining words. The Porter stemming algorithm is a method that removes many common endings from words in English to create normalized core words. After the Porter stemming algorithm was applied, a normalized list of words remained. If the list for a particular Web page contained less than 50 words it was removed, since Web pages containing such short lists were frequently found not refer to the concept under consideration.

The lists of words were then combined to form the training corpus for each concept. The large numbers of Web pages used allow multiple training corpora to be generated for each concept and each site. More specifically, for each of the Web sites used for the evaluation, the collected data were divided into ten sets. The ten sets were then used to generate ten training corpora. The generation of ten training corpora for each site allowed one training corpora to be withheld for testing against a classifier generated using the other nine training corpora, in other words, an internal evaluation.

After the processing of the lists of words from the Web pages was complete, a term frequency-inverse document frequency (TF-IDF) weighting was applied to each training corpus. The TF-IDF weight is a statistical measure used to evaluate how important a word is to a document in a corpus. The importance increases proportionally to the number of times a word appears in the document, but is offset by the frequency of the word in the corpus.

Binary classifiers for each concept were then built using an SVM, as discussed with respect to block 208 of FIG. 2. The SVM provides a classifying hyperplane between the negative and positive examples in each training corpus for each concept. However, an SVM generally poses a complex quadratic programming (QP) problem because there is an exponential increase in the number of calculations as the number of categories to be explored is increased. Effects of this problem can be reduced by using a sequential minimal optimization (SMO) algorithm. SMO is a simple algorithm that solves the SVM QP problem without any extra matrix storage and without using numerical QP optimization steps. SMO breaks the SVM QP problem into a number of QP sub-problems.

Solution of the SVM provides a classification function that converts the identity and frequency of words in a target content object into a numerical prediction that the content object is within a certain category. The techniques tested were evaluated by the accuracy of the classification averaged over all categories. In the test cases, this is generally similar to the F-Measure, since the corpora have balanced class distributions.

Cross-validation was performed to compare results from classification tests on different corpora. However, it generally does not apply well to the case of transferring classifiers to different types of Web pages, due to differences in the distributions. In exemplary embodiments of the present invention, the training corpus is not assumed to resemble the distribution of Web pages at deployment time or even to be fixed. For example, the distribution might vary from user to user of a classification system.

Further, each training corpus can contain noise (mislabeled examples) and systematic mistakes (missing links between categories etc.). For example, the DMOZ™ concept of photography does not include the node underwater photography. Furthermore, even if a DMOZ™ category name, a DELICIOUS™ tag, and a WIKIPEDIA™ page title are identical, this does not imply that the underlying semantics are also identical. However, even if the semantics are different, generally large parts of the different taxonomies, tags, and labels will still agree. The degree of agreement can be interpreted as compatibility when it comes to using different corpora in the same experiment. Accordingly, results for a concept learned from terms obtained from DMOZ™ can provide a good indication of what the same concept in terms of other Web sites, for example, DELICIOUS™, might look like.

Exemplary embodiments of the present invention allow for learning classifiers for each source, even if that source is not part of the training set. This is similar to hold-out evaluation, in which a portion of a data set is held out for later testing. In this case, it is data sources, such as a training set from a particular Web site that can be held out. As discussed above, each of the training data sets for each of the Web sites used was divided into ten, allowing one tenth of the training data to be held out for evaluation.

The classification functions were tested by using information items from various training corpora as content objects. The content objects were classified by the method 300 generally discussed with respect to FIG. 3. Quantification of the difference between corpora for the various information sources, as well as the generality of a classifier learned under specific circumstances can be performed by a cross-corpus evaluation.

Cross-corpus evaluation is performed by training a classifier on a first corpus and then measuring its performance on a second corpus. For any pair of corpora that share a common underlying distribution, the expected cross-validation and cross-corpus evaluation results could be identical. In contrast, for a pair of highly incompatible corpora, applying the classifiers to the other corpus would result in much lower classification accuracies.

As an initial test, a baseline method was performed which simply ignored any different characteristics of the Web corpora. In this technique, the data of the three corpora that are used for training were merged and an SVM classifier was generated for that single training data set. To begin evaluating the different methods, the corresponding cross-corpus evaluation can be evaluated.

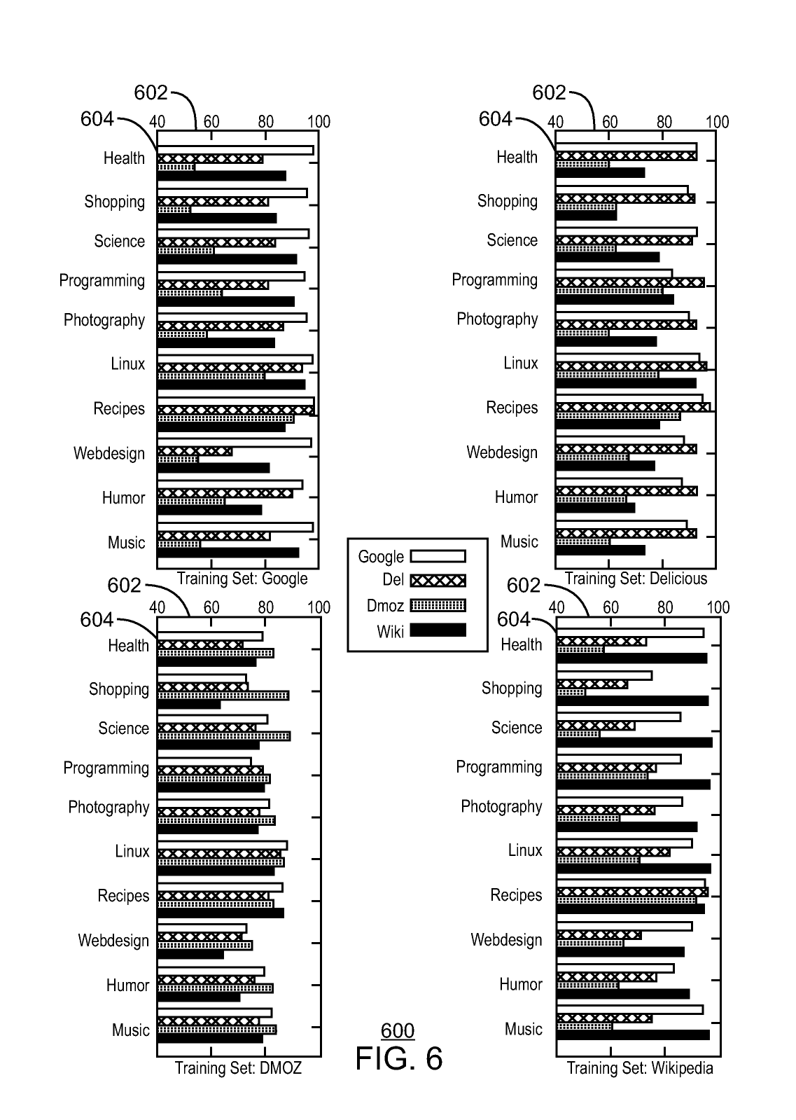

FIG. 6 is a bar chart comparing classification results for training sets taken from each of the target Web sites used, in accordance with an exemplary embodiment of the present invention. The bar chart illustrates cross-corpus evaluation results at the category level. Specifically, the percentage agreement between sets is indicated by the top axis 602, wherein 100 is complete agreement, and 40 is very low agreement. The specific categories tested are shown on the vertical axis 604. Each of the four blocks describes the result for a common training set. The different test sets are indicated by shading of each of the bars. For each pair of category and data source, a separate classifier was created and then applied to all data sets of the same category. Averages of ten-fold cross-validation results were substituted whenever the same source was used for training and testing, for example, when a test set was withheld from the data, the training results from the remaining data is shown. The data represented in FIG. 6 was aggregated and the remaining results discussed below are aggregates. Table 1 shows aggregate overall results where a classifier was built from the training corpora from a particular source Web site (listed as the rows) and applied to a training corpus from another Web site (listed as the columns).

The cross-validation accuracies along the main diagonal in Table 1 are generated by classifying a test data set withheld from the generation of the training corpora using the classifier generated from the remaining test data sets for any each Web site. This is repeated for each of the ten test data sets in each training corpora to generate ten results, which are then averaged. The diagonal numbers can be referred to as the upper-bounds of the accuracy, because the error rate for these samples is an artifact of the learning strategy and generally not caused by a difference between the distributions of the training and test sets.

TABLE 1
Results of cross-corpus evaluation¹.

| | Google | Delicious | DMOZ | Wikipedia |
|---|---|---|---|---|
| Google | (96.44)² | 84.17 | 63.42 | 87.12 |
| Delicious | 90.00 | (93.54)² | 68.36 | 76.71 |
| DMOZ | 79.98 | 77.15 | (83.92)² | 75.84 |
| Wikipedia | 88.28 | 76.21 | 65.05 | (94.26)² |

¹Rows are the training sets, columns are the test sets.
²Data along diagonal was measured by testing a withheld data corpus against a classifier generated from the remaining data corpora, and repeating for each of the ten training corpora.

In Table 1, the highest accuracy achieved by any other corpus for each test corpus in shown in bold and the lowest accuracy is shown in italics. The bolded numbers can represent reasonable lower-bounds for how much of the “real” concept is reflected on average by the corpus and are reproduced as the first line in Table 2, below.

Various methods may be used for combining the training corpora to achieve higher predictive accuracy, as generally discussed with respect to block 210 of FIG. 2. One exemplary method, which may be termed the “equal weight combination,” provides an accuracy shown in the second line of Table 2. In this method, for each category, the corpora for each of three different training sources were combined using equal weighting and tested on the remaining corpora (listed in the other columns). For example, when a single training corpus is created by combining the data (positive and negative) of DELICIOUS™, DMOZ™ and WIKIPEDIA™ for each concept, it gives 76.94% accuracy on average on the 10 GOOGLE™ corpora. It should be noted that the training sets in this test are three times larger than in the cross-corpus matrix.

TABLE 2
Results from different methods for combining training corpora.

| | Google | Delicious | DMOZ | Wikipedia |
|---|---|---|---|---|
| Best Single Cross-corpus | 90.00 | 84.17 | 68.36 | 87.12 |
| Result¹ | | | | |
| Equal Weight Combination | 76.94 | 76.47 | 68.74 | 76.79 |
| Majority Vote | 92.95 | 84.45 | 65.10 | 84.44 |
| Weighted Training Instances | 93.88 | 84.65 | 66.08 | 85.73 |
| Weighted & Noise93.29 | 87.52 | 70.21 | 87.50 | |
| Elimination | | | | |

¹Best results from Table 1 (as shown in bold)

However, even considering the larger training sets, the accuracy of the equal weight combination is poor in comparison to the values indicated in the first line of Table 2. The results for the equal weight combination indicate that the corpora from each Web site differ considerably, and mixing them blindly may provide noisy, heterogeneous, and non-separable corpora that contain some level of systematic contradiction. Exemplary embodiments of the present invention provide methods for combining the training corpora from different Web sites to generate more accurate results, as discussed below

Combining Corpora by Majority Vote

In another exemplary method that is used to combine training corpora, as generally discussed with respect to block 210 of FIG. 2, the results of separate classifiers obtained for each training corpus from each Web site are averaged. Specifically, the classifiers generated from three of the corpora were used on concepts for Web pages from the fourth corpora to generate SVM output predictions. The SVM outputs were then scaled to generate calibrated probability estimates that a Web page represented a specific concept. The calibrated probability estimates were then averaged to generate a classification, providing the accuracy shown in line 3 of Table 2. The results indicate that keeping the corpora separate during training provides results that are close to the results obtained from the single cross-corpus classifier shown in the first line of Table 2.

Combining Corpora by Weighting Training Data

In another exemplary method that is used to combine training corpora, as generally discussed with respect to block 210 of FIG. 2, classifications from a subset of the training corpora were used to force a response in another corpus. This is performed prior to generating a classifier from the corpus. Generally, this strategy enforces agreement between the different source Web sites on the same concept. This can lower the effects of noisy data, for example, due to bad references in data obtained from a training Web sites. Further, the use of weighted training can lower the effects of imperfect training.

To test this approach, the data from each of the training corpora were used to generate separate classifiers for each of the test concepts. The classifiers were then used to generate a weighted version of each category-specific training set. For any specific source of training corpora “B,” in computing the weight of a concept e_{B}, having a word vector x_{B} and a label y_{B}, the classifiers trained from the source B, itself, were excluded. An unweighted majority vote of the classifiers from the remaining sources was then performed to determine the weights. More specifically, each of the binary classifiers not trained from B gave a calibrated probability estimate P(y_{B}|x_{B}) for the concept e_{B} for each category. The average of those estimates was then used as the weight for e_{B}. The training examples were then required to have agreement between classifiers trained from different sources in order to receive a high weight.

Accordingly, for each of the three training corpora available per category (with the fourth held out for testing), there were two classifiers available to determine the weights of concepts in third training corpus. After the weighting was performed, the weighted data was used in training the classifier. Finally, the classifiers generated were tested against the test corpora of the fourth source. The averaged accuracies of the classification test in which weighted test sets were used for training are shown as “weighted training instances” in line 4 of Table 2. The results show substantial improvement over the results of the baseline method shown in line 2 and were comparable to the performance of majority voting.

In another exemplary method that is used to combine training corpora, as generally discussed with respect to block 210 of FIG. 2, all examples for which a majority (two in this case) of the classifiers from the other sources predicted an opposite result were excluded. Generally, bad conventions, missing or questionable links between categories, and other kinds of white and systematic noise all share the property that they are not found across multiple sources, but are local problems. Eliminating a result that disagrees with the results from a majority of the other training corpora can reduce these effects. This was further enhanced by assigning the highest possible weight when the majority (both) of the classifiers from the other sources predicted the same results. The last line in Table 2, labeled “weighted & noise elimination” shows the results for this stronger noise reduction and emphasis on agreement. The averaged accuracies are higher for DELICIOUS™, DMOZ™ and WIKIPEDIA™ compared to using weighting training instances, as shown in line 4. This technique outperformed the best single-corpus accuracy shown in line 1.

Methods according to an exemplary embodiment of the present invention are not limited to the combinations or Web sites shown above. Other mathematical combinations of the training corpora can be envisioned, such as weighting examples from sources that more closely resemble targeted types of content to higher levels. Further, additional sources could be added for generating training sets, such as news Web sites, which could be used as training sites for sorting news feeds. If additional Web sites are added that generally cover the same type of content, such as using both GOOGLE™ and ALTAVISTA™ as search engine sources, the content can be weighted to lower (or even to increase) the importance of the similar Web sites relative to other types of Web sites.

What is claimed is:

1. A computer implemented method for classifying information, comprising:
accessing a plurality of information sources to identify information items for each of a plurality of classification categories;
analyzing each of the information items to generate a training corpus for each information source for each of the classification categories; and
combining the training corpus for each information source to generate a training set for each of the classification categories, wherein the training set is configured to allow the generation of a classification function.

2. The method of claim 1, wherein the information sources comprise Web sites.

3. The method of claim 1, wherein the information items comprise Web pages.

4. The method of claim 1, comprising transforming the classification function into a visual representation of items that comprise a physical system.

5. The method of claim 2, wherein the Web sites include at least one of a social networking sites, on-line encyclopedias, social indexing sites, social commentary sites, search engines, or news sites.

6. The method of claim 1, wherein the classification function comprises a support vector machine (SVM).

7. The method of claim 1, wherein the classification categories include at least one of concepts, topics, sub-topics, words from headings, words from titles, subjects, or activities.

8. The method of claim 1, wherein analyzing each of the information items comprises:
tokenizing the information item to generate a list of words;
removing non-substantive words from the list; and
applying a stemming algorithm to generate a final list.

9. The method of claim 1, wherein combining the training corpus comprises:
generating a classification function for each of the classification categories from each of the information sources;
generating a probability function for each of the classification functions, the probability function to generate a probability that a content object belongs to a particular classification; and
averaging the probabilities to classify a content object.

10. The method of claim 1, wherein combining the training corpus comprises:
generating a classification function for each of the classification categories from each of the information sources;
classifying a content object using each classification function; and
placing a content object in the classification identified by a majority of the classification functions.

11. The method of claim 1, wherein combining the training corpus comprises:
generating a classification function for each of the classification categories for a majority of the information sources;
using the classification functions from a majority of the information sources to classify information items for a withheld information source;
weighting the information items from the withheld information source based on the results from the classification functions from the majority of the information sources; and
generating a classification function for the withheld information source using the weighted information items.

12. The method of claim 1, wherein combining the training corpus comprises:
generating a classification function for each of the classification categories for a majority of the information sources;
using the classification functions from the majority of the information sources to classify information items for a withheld information source;
removing an information item for a classification category when a substantial majority of classification functions generated from other information sources provide an opposite result.

13. The method of claim 1, comprising:
analyzing a content object to generate a list of keywords;
applying the classification function to each of the keywords to generate a classification factor for each of the classification categories that represents whether a content object is within that category;
summing the classification factors for each of the classification categories; and
classifying the content object by the sum of the classification factors.

14. The method of claim 13, wherein the content object comprises at least one of a Web page, a text article, an encyclopedia article, or a text message.

15. The method of claim 13, comprising providing content objects that are within a classification category to a user system.

16. A system for classifying a content object, comprising:
a processor;
a network interface; and
a tangible, machine readable medium comprising code configured to direct the processor to:
obtain a content object over the network interface;
analyze the content object to generate a list of keywords;
apply a classification function to each of the keywords to generate a classification factor that represents whether the content object is in a classification category, wherein:
the classification function is generated by combining a plurality of individual classification functions generated from each of a plurality of training corpora; and
each of the training corpora is generated from information items identified on a separate information source;
sum the classification factors for each classification category; and
classify the content object by the sum of the classification factors.

17. The system of claim 16, comprising a user interface, wherein the user interface comprises a monitor and wherein the tangible, machine readable medium comprises code configured to direct the processor to display the results of the classification on the monitor.

18. The system of claim 16, wherein the tangible, machine readable medium comprises code configured to direct the processor to send content objects over the network interface to subscribers based on the classification categories of the content objects.

19. A tangible, computer readable medium, comprising code configured to direct a processor to:
access a plurality of information sources to identify information items for each of a plurality of classification categories;
analyze each of the information items to generate a training corpus for each information source for each of the classification categories; and
combine the training corpus for each of the information sources to generate a training set for each of the classification categories, wherein the training set is configured to allow the generation of a classification function.

20. The tangible, computer readable medium of claim 19, comprising code configured to direct a processor to:
analyze the text of a content object to generate a list of keywords;
apply the classification function to each of the keywords to generate a classification factor that represents whether the content object is in a classification category;
sum the classification factors for each classification category; and
classify the content object by the sum of the classification factors.
